(19) United States
(12) Patent Application Publication
(10) Pub. No.: US 2010/0049919 A1
(43) Pub. Date: Feb. 25, 2010

(54) SERIAL ATTACHED SCSI (SAS) GRID STORAGE SYSTEM AND METHOD OF OPERATING THEREOF

(75) Inventors: Alex WINOKUR, Haifa (IL); Haim KOPYLOVITZ, Herzliya (IL)

Correspondence Address: OLIFF & BERRIDGE, PLC, P.O. BOX 320850, ALEXANDRIA, VA, 22320-4850, US

(73) Assignee: XSIGNNET LTD., Herzliya Pituach (IL)

(21) Appl. No.: 12/544,743

(22) Filed: Aug. 20, 2009

Related U.S. Application Data
(60) Provisional application No. 61/189,755, filed on Aug. 21, 2008.
(60) Provisional application No. 61/151,528, filed on Feb. 11, 2009.

(51) Int. Cl. G06F 12/00; G06F 13/12; G06F 12/16

(52) U.S. Cl. 711/114; 710/74; 711/162; 711/E12.001

(57) ABSTRACT

There is provided a SAS grid storage system and a method of operating thereof. The system comprises a) a storage control grid comprising a plurality of interconnected data servers operable in accordance with at least one SAS protocol and b) a plurality of disk units adapted to store data at respective ranges of logical block addresses (LBAs), said addresses constituting an entire address space. Each disk unit comprises at least one input/output (IO) module comprising at least one internal SAS expander configured as a target with regard to the storage control grid. The plurality of disk units is operatively connected to the storage control grid in a manner enabling to each data server comprised in the storage control grid an access to each disk unit among the plurality of disk units. The method of operating the grid storage system comprises: a) assigning each LBA to a primary data server configured to have a primary responsibility for permanent storing of data and/or metadata related to the desired LBA, a secondary data server configured to take over the responsibility for said permanent storing in an event of a failure of the primary data server, and, optionally, to auxiliary secondary data server configured to take over the responsibility for said permanent storing in an event of a failure of the secondary data server; b) responsive to an I/O requests directed to a certain LBA, temporarily storing the data and metadata with respect to desired LBA in the primary data server; c) sending copies of said data/metadata from the primary data server to respective secondary data servers for temporarily storing; and d) sending permissions from the primary data server to the secondary data servers to delete the copy of data/metadata upon successful permanent storing said data/metadata.

### CROSS-REFERENCES TO RELATED APPLICATIONS

This application relates to and claims priority from U.S. Provisional Patent Applications No. 61/189,755, filed on Aug. 21, 2008 and 61/151,528 filed Feb. 11, 2009. Both applications are incorporated herein by reference in their entirety.

### FIELD OF THE INVENTION

The present invention relates, in general, to data storage systems and respective methods for data storage, and, more particularly, to mass storage systems and methods employing SAS (serial Attached SCSI) protocol.

### BACKGROUND OF THE INVENTION

Modern enterprises are investing significant resources to preserve and provide access to data, despite failures. Data protection is a growing concern for businesses of all sizes. Users are looking for a solution that will help to verify that critical data elements are protected, and storage configuration can enable data integrity and provide a reliable and safe switch to redundant computing resources in case of an unexpected disaster or service disruption.

To accomplish this, storage systems may be designed as fault tolerant systems spreading data redundantly across a set of storage-nodes and enabling continuous operating when a hardware failure occurs. Fault tolerant data storage systems may store data across a plurality of disk drives and may include duplicate data, parity or other information that may be employed to reconstruct data if a drive fails. Data storage formats, such as RAID (Redundant Array of Independent Discs), may be employed to protect data from internal component failures by making copies of data and rebuilding lost or damaged data. As the likelihood for two concurrent failures increases with the growth of disk array sizes and increasing disk densities, data protection may be implemented, for example, with the RAID 6 data protection scheme well known in the art.

Common to all RAID 6 protection schemes is the use of two parity data portions per several data groups (e.g. using groups of four data portions plus two parity portions in (4+2) protection scheme, using groups of sixteen data portions plus two parity portions in (16+2) protection scheme, etc.), the two parities being typically calculated by two different methods. Under one well-known approach, all n consecutive data portions are gathered to form a RAID group, to which two parity portions are associated. The members of a group as well as their parity portions are typically stored in separate drives. Under a second approach, protection groups may be arranged as two-dimensional arrays, typically n*n, such that data portions in a given line or column of the array are stored in separate disk drives. In addition, to every row and to every column of the array a parity data portion may be associated. These parity portions are stored in such a way that the parity portion associated with a given column or row in the array resides in a disk drive where no other data portion of the same column or row also resides. Under both approaches, whenever data is written to a data portion in a group, the parity portions are also updated using well-known approaches (e.g. such as XOR or Reed-Solomon). Whenever a data portion in a group becomes unavailable, either because of disk drive general malfunction or because of a local problem affecting the portion alone, the data can still be recovered with the help of one parity portion, via well-known techniques. Then, if a second malfunction causes data unavailability in the same drive before the first problem was repaired, data can nevertheless be recovered using the second parity portion and the related, well-known techniques.

While the RAID array may provide redundancy for the data, damage or failure of other components within the subsystem may render data storage and access unavailable.

Fault tolerant storage systems may be implemented in a grid architecture including modular storage arrays, a common virtualization layer enabling organization of the storage resources as a single logical pool available to users and a common management across all nodes. Multiple copies of data, or parity blocks, should exist across the nodes in the grid, creating redundant data access and availability in case of a component failure. Emerging Serial-Attached-SCSI (SAS) techniques are becoming more and more common in fault tolerant grid storage systems. Examples of SAS implementations are described in detail in the following documents, each of which is incorporated by reference in its entirety:
“Serial Attached SCSI-2 (SAS-2)”, Revision 16, Apr. 18, 2009. Working Draft, Project T10/1760-D, Reference number ISO/IEC 14776-152:200x. American National Standard Institute.
“Serial Attached SCSI Technology”, 2006, by Hewlett-Packard Corp., http://h20000.www2.hp.com/bc/docs/support/SupportManual/c00302340/c00302340. pdf

The problems of effective employing of SAS technology in grid storage systems have been recognized in the Prior Art and various systems have been developed to provide a solution, for example:

US Patent Application No. 2009/094620 (Kalvitz et al.) discloses a storage system including two RAID controllers, each having two SAS initiators coupled to a zoning SAS expander. The expanders are linked by an inter-controller link and create a SAS ZPSDS. The expanders have PHY-to-zone mappings and zone permissions to create two distinct SAS domains such that one initiator of each RAID controller is in one domain and the other initiator is in the other domain. The disk drives are dual-ported, and each port of each drive is in a different domain. Each initiator can access every drive in the system, half directly through the local expander and half indirectly through the other RAID controllers expander via the inter-controller link. Thus, a RAID controller can continue to access a drive via the remote path in the remote domain if the drive becomes inaccessible via the local path in the local domain.

US Patent Application No. 2008/162987 (El-Batal) discloses a system comprising a first expander device and a second expander device. The first expander device and the second expander device comprise a subtractive port and a table mapped port and are suitable for coupling a first serial attached SCSI controller to a second serial attached SCSI controller. The first and second expander devices are cross-coupled via a redundant physical connection.

US Patent Application No. 2007/094472 (Cherian et al.) discloses a method for mapping disk drives of a data storage system to server connection slots. The method may be used when an SAS expander is used to add additional disk drives, and maintains the same drive numbering scheme as would exist if there were no expander. The method uses the IDENTIFY address frame of an SAS connection to determine whether a device is connected to each PHY of a controller port, and whether the device is an expander or end device.

US Patent Application No. 2007/088917 (Ranaweera et al.) discloses a system and method of maintaining a serial attached SCSI (SAS) logical communication channel among a plurality of storage systems. The storage systems utilize a SAS expander to form a SAS domain comprising a plurality of storage systems and/or storage devices. A target mode module and a logical channel protocol module executing on each storage system enable storage system to storage system messaging via the SAS domain.

US Patent Application No. 2007/174517 (Robillard et al.) discloses a data storage system including first and second boards disposed in a chassis. The first board has disposed thereon a first Serial Attached Small Computer Systems Interface (SAS) expander, a first management controller (MC) in communication with the first SAS expander, and management resources accessible to the first MC. The second board has disposed thereon a second SAS expander and a second MC. The system also has a communications link between the first and second MCs. Primary access to the management resources is provided in a first path which is through the first SAS expander and the first MC, and secondary access to the first management resources is provided in a second path which is through the second SAS expander and the second MC.

### SUMMARY OF THE INVENTION

In terms of software and protocols, SAS technology supports thousands of devices allowed to communicate with each other. However, the physical enclosure in which the technology is implemented in the prior art does impose limitations at various levels of the hardware used, such as for example, the amount of connection ports and the amount of targets supported by the specific chipset implemented in the specific hardware. These limitations are not inherent to the SAS protocol. Among advantages of certain embodiments of the present invention is a capability of more efficient usage of the features inherently afforded by the SAS protocol. Among further advantages of certain embodiments of the present invention is enhanced availability and failure protection of the SAS grid storage system.

In accordance with certain aspects of the present invention, there is provided a storage system comprising a) a storage control grid comprising a plurality of interconnected data servers operable in accordance with at least one SAS protocol and b) a plurality of disk units adapted to store data at respective ranges of logical block addresses (LBAs), said addresses constituting an entire address space. Bach disk unit comprises at least one input/output (IO) module comprising at least one internal SAS expander operative in accordance with at least one SAS protocol and configured as a target with regard to the storage control grid. The plurality of disk units is operatively connected to the storage control grid in a manner enabling to each data server comprised in the storage control grid an access to each disk unit among the plurality of disk units. The storage system may be operable, for example, in accordance with file-access storage protocols, block-access storage protocols and/or object-access storage protocols.

In accordance with further aspects of the present invention, a data server may be configured to be responsible for handling I/O requests directed to a respective part of the entire address space. Each certain data server may be further operative to recognize among received I/O requests a request directed to an address space out of the server's responsibility and to re-directed such request to a server responsible for the desired address space. The data servers may be configured to be responsible for handling all I/O requests addressed to directly accessible address space or a pre-defined part of such requests.

In accordance with further aspects of the present invention, the storage control grid may further comprise a plurality of SAS expanders, each SAS expander directly connected to at least two interconnected data servers and each data server is directly connected to at least two SAS expanders, and wherein each disk unit is directly connected to at least two SAS expanders and each SAS expander is directly connected to all disk units thus enabling direct access of each data server to the entire address space. Disk unit may comprise at least two I/O modules each comprising at least two internal SAS expanders, wherein each disk drive comprised in a certain disk unit is connected to at least one internal SAS expander in each of the I/O modules.

Alternatively, at least two disk units in the plurality of disk units may be connected in one or more daisy chains, the first and the last disk units in each daisy chain are directly connected to at least two servers, the connection is provided independently of other daisy chains. Each data server may be connected to one or more said daisy chains and be configured, responsive to an I/O request from a host processor directed to a certain LBA, to re-direct the I/O request to another server if said LBA is not comprised in the LBA ranges of disk units in respective daisy chains connected to said server. Disk unit may comprise at least two I/O modules each comprising at least two internal SAS expanders, wherein each disk drive comprised in the disk unit may be connected to at least one internal SAS expander in each of the I/O modules. I/O module may further comprise at least two Mini SAS each connected to a respective internal SAS expanders and enabling required interconnection of disk units with respective servers and/or within the daisy chains.

In accordance with further aspects of the present invention, each LBA may be assigned to at least two data servers, a primary data server configured to have a primary responsibility for permanent storing of data and/or metadata related to the desired LBA, and a secondary data server configured to take over the responsibility for said permanent storing in an event of a failure of the primary data server. All I/O requests directed to a certain LBA are handled by respective primary data server. Said primary data server is operable to temporarily store the data and metadata with respect to desired LBA, to send a copy of said data/metadata to respective secondary data server for temporarily storing; and to send a permission to the secondary data server to delete the copy of data/metadata upon successful permanent storing said data/metadata.

In accordance with further aspects of the present invention, each LBA may be assigned to at least three data servers, a primary data server configured to have a primary responsibility for permanent storing of data and/or metadata related to the desired LBA, a main secondary data server configured to take over the responsibility for said permanent storing in an event of a failure of the primary data server, and an auxiliary secondary server configured to take over the responsibility for said permanent storing in an event of a failure of the main secondary data server. All I/O requests directed to a certain LBA are handled by respective primary server. Said primary server is operable to temporarily store the data and metadata with respect to desired LBA, to send copies of said data/metadata to respective main and auxiliary secondary servers for temporarily storing; to send permissions to the main and auxiliary secondary servers to delete the copies of data/metadata upon successful permanent storing said data/metadata.

In accordance with other aspects of the present invention, there is provided a method of operating a storage system comprising a storage control grid comprising a plurality of interconnected data servers operable in accordance with at least one SAS protocol; and a plurality of disk units adapted to store data at respective ranges of logical block addresses (LBAs), wherein said plurality of disk units is operatively connected to the storage control grid in a manner enabling to each data server comprised in the storage control grid an access to each disk unit among the plurality of disk units. The method comprises: a) assigning each LBA to at least two data servers, a primary data server configured to have a primary responsibility for permanent storing of data and/or metadata related to the desired LBA, and a secondary data server configured to take over the responsibility for said permanent storing in an event of a failure of the primary data server; b) responsive to an I/O requests directed to a certain LBA, temporarily storing the data and metadata with respect to desired LBA in the primary data server; c) sending a copy of said data/metadata from the primary data server to respective secondary data server for temporarily storing; and d) sending a permission from the primary data server to the secondary data server to delete the copy of data/metadata upon successful permanent storing said data/metadata.

In accordance with further aspects of the present invention, the method comprises: a) assigning each LBA to at least three data servers, a primary data server configured to have a primary responsibility for permanent storing of data and/or metadata related to the desired LBA, a main secondary data server configured to take over the responsibility for said permanent storing in an event of a failure of the primary data server, and an auxiliary secondary server configured to take over the responsibility for said permanent storing in an event of a failure of the main secondary data server; b) responsive to an I/O requests directed to a certain LBA, temporarily storing the data and metadata with respect to desired LBA in the primary data server; c) sending copies of said data/metadata from the primary data server to respective main and auxiliary secondary data servers for temporarily storing; and d) sending a permission from the primary data server to the main and auxiliary secondary data servers to delete the copies of data/metadata upon successful permanent storing said data/metadata.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a schematic functional block diagram of a SAS-based grid storage system in accordance with certain embodiments of the present invention;

FIG. 2 illustrates a schematic functional block diagram of a SAS server in accordance with certain embodiments of the present invention;

FIG. 3 illustrates a schematic functional block diagram of a SAS disk unit in accordance with certain embodiments of the present invention; and

FIG. 4 illustrates a schematic functional block diagram of a SAS-based grid storage system in accordance with certain alternative embodiments of the present invention.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “activating”, “reading”, “writing”, “classifying”, “allocating” or the like, refer to the action and/or processes of a computer that manipulate and/or transform data into other data, said data represented as physical, such as electronic, quantities and/or representing the physical objects. The term “computer” should be expansively construed to cover any kind of electronic device with data processing capabilities, including, by way of non-limiting example, personal computers, servers, computing system, communication devices, storage devices, processors (e.g. digital signal processor (DSP), microcontrollers, field programmable gate array (FPGA), application specific integrated circuit (ASIC), etc.) and other electronic computing devices.

The operations in accordance with the teachings herein may be performed by a computer specially constructed for the desired purposes or by a general purpose computer specially configured for the desired purpose by a computer program stored in a computer readable storage medium.

Embodiments of the present invention are not described with reference to any particular programming language. It will be appreciated that a variety of programming languages may be used to implement the teachings of the inventions as described herein.

The references cited in the background teach many principles of cache-comprising storage systems and methods of operating thereof that are applicable to the present invention. Therefore the full contents of these publications are incorporated by reference herein where appropriate for appropriate teachings of additional or alternative details, features and/or technical background.

In the drawings and descriptions, identical reference numerals indicate those components that are common to different embodiments or configurations.

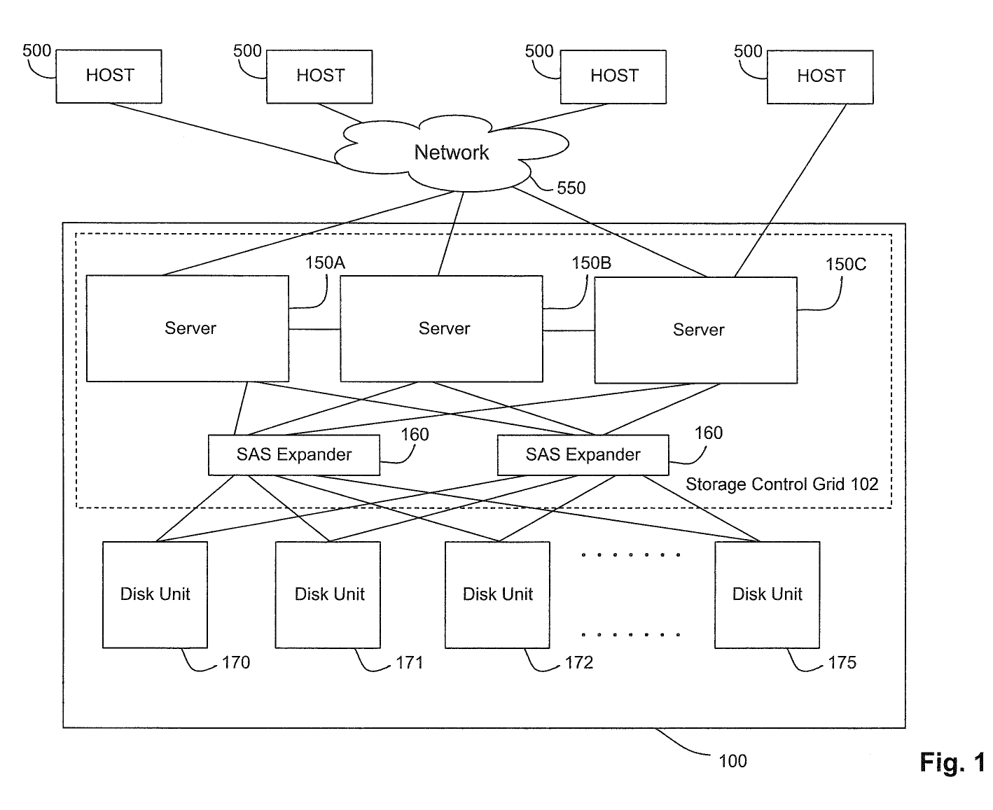

Bearing this in mind, attention is drawn to FIG. 1 illustrating a schematic functional block-diagram of SAS-based grid storage system in accordance with certain embodiments of the present invention.

A plurality of host computers (illustrated as 500) may share common storage means provided by a grid storage system 100. The storage system comprises a storage control grid 102 comprising a plurality of servers (illustrated as 150A, 150B, 150C) operatively coupled to the plurality of host computers and operable to control I/O operations between the plurality of host computers and a grid of storage nodes comprising a plurality of disk units (illustrated as 171-175). The storage control grid 102 is further operable to enable necessary data virtualization for the grid nodes and to provide placing the data on the nodes.

Typically (although not necessarily), the servers in the storage control grid may be off-the-shelf computers running a Linux operating system. The servers are operable to enable transmitting data and control commands, and may be interconnected via any suitable protocol known in the art (e.g. TCP/IP, Infiniband, etc.)

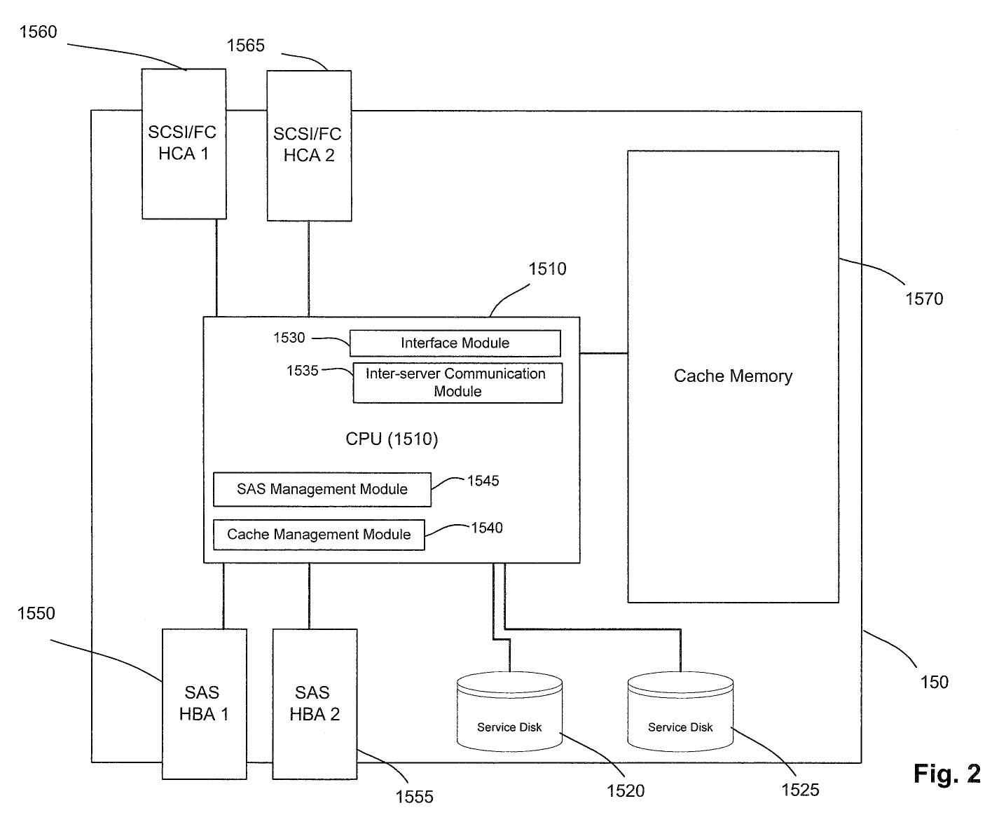

Any individual server of the storage control grid 102 may be operatively connected to one or more hosts 500 via a fabric 550 such as a bus, or the Internet, or any other suitable means known in the art. The servers are operable in accordance with at least one SAS protocol and configured to control I/O operations between the hosts and respective disk units. The servers' functional block-diagram is further detailed with reference to FIG. 2.

Storage virtualization enables referring to different physical storage devices and/or parts thereof as logical storage entities provided for access by the plurality of hosts. Stored data may be organized in terms of logical volumes (LVs) each identified by means of a Logical Unit Number (LUNs). A logical volume is a virtual entity comprising a sequence of data blocks. Different LVs may comprise different numbers of data blocks, while the data blocks are typically of equal size. Data storage formats, such as RAID (Redundant Array of Independent Discs), may be employed to protect data from internal component failures.

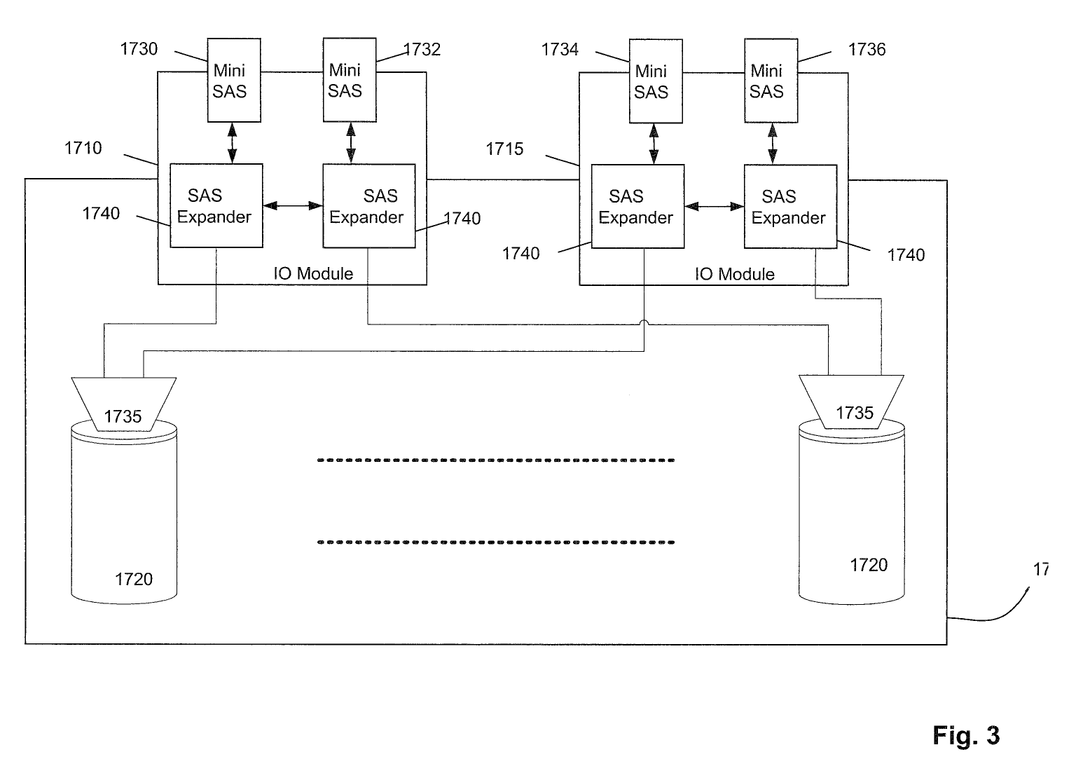

Each of the disk units (DUs) 170-175 comprises two or more disk drives operable with at least one SAS protocol (e.g. DUs may comprise SAS disk drives, SATA disk drives, SAS tape drives, etc.). The disk units are operable to store data at respective ranges of logical block addresses (LBAs), said addresses constituting an entire address space. Typically a number of disk drives constituting the disk unit shall enable adequate implementation of the chosen protection scheme (for example, disk units may comprise a multiple of 18 disk drives for RAID6 (16+2) protection scheme). The DUs functional block-diagram is further detailed with reference to FIG. 3.

In accordance with certain embodiments of the present invention, the storage control grid 102 further comprises a plurality of SAS expanders 160. A SAS expander can be generally described as a switch that allows multiple initiators and targets to communicate with each other, and allows additional initiators and targets to be added to the system (up to thousands of initiators and targets in accordance with SAS-2 protocol). The so-called “initiator” refers to the end in the point-to-point SAS connection that sends out commands, while the end that receives and executes the commands is considered as the “target.”

In accordance with certain embodiments of the present invention, each disk unit is directly connected to at least two SAS expanders 160; each SAS expander is directly connected to all disk units. Each SAS expander is further directly connected to at least two interconnected servers comprised in the storage control grid. Each such server is directly connected to at least two SAS expanders. Thus each server has direct access to entire address space of the disk units.

Unless specifically stated otherwise, the term “direct connection of SAS elements” used in this patent specification shall be expansively construed to cover any connection between two SAS elements with no intermediate SAS element or other kind of server and/or CPU-based component. The direct connection between two SAS elements may include remote connection which may be provided via Wire-line, Wireless, cable, Internet, Intranet, power, satellite or other networks and/or using any appropriate communication standard, system and/or protocol and variants or evolution thereof (as, by way of unlimited example, Ethernet, iSCSI, Fiber Channel, etc.).

Unless specifically stated otherwise, the term “direct access to a target and/or part thereof” used in this patent specification shall be expansively construed to cover any serial point-to-point connection to the target or part thereof without any reference to an alternative point-to-point connection to said target. The direct access may be implemented via direct or indirect (serial) connection between respective SAS elements.

Referring to FIG. 2, there is illustrated a schematic functional block diagram of the SAS server in accordance with certain embodiments of the present invention (e.g. server 150A illustrated in FIG. 1). The server comprises a CPU 1510 operatively coupled to a plurality of service disk drives (illustrated as disk drives 1520 and 1525), that may serve various operational tasks, such as storing meta-data used by the system, emergency storage tasks, etc. The server may also comprise a memory area 1570 operable as a cache memory used during I/O operation and operatively coupled to the CPU. The server further comprises one or more Host Channel Adapters (HCA's) (illustrated as HCA's 1560 and 1565) operatively connected to the CPU and operable to enable communication with the hosts 500 in accordance with appropriate protocols. The server further comprises two or more SAS Host Bus Adapters (HBA's) (illustrated as HBA's 1550 and 1555) operable to communicate with the SAS expanders 160 and to enable the respective data flow. The CPU further comprises a Cache Management Module 1540 operable to control the cache operating, a SAS Management Module 1545 controlling communication and data flow within the Storage Control Grid, an interface module 1530 and an Inter-server Communication Module 1535 enabling communication with other servers in the storage control grid 102.

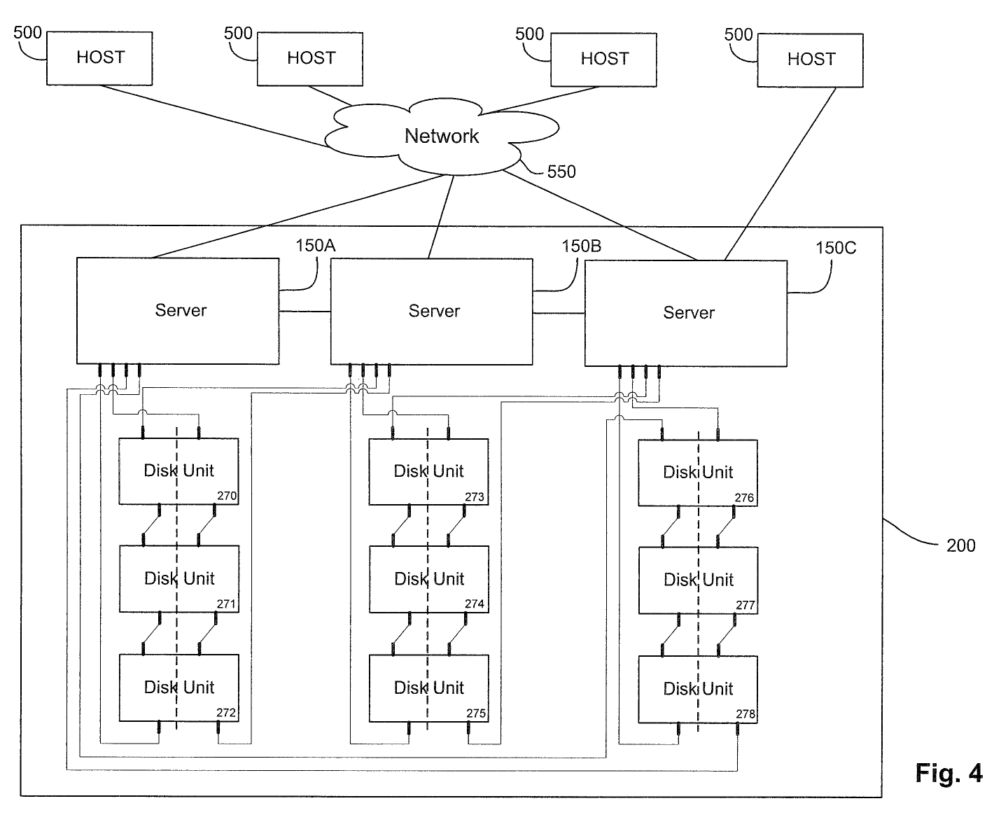

In certain embodiments of the invention one or more servers may have, in addition, indirect access to disk units connected to the servers via SAS expanders or otherwise (e.g. as illustrated with reference to FIG. 4). The server may be further configured to be responsible for handling I/O requests addressed to directly accessible disks. When the server receives an I/O request, the interface module 1530 checks if the request is directed to the address space within the responsibility of said server. If the request (or part thereof) is directed to an address space out of the server's responsibility, the request is re-directed via the inter-server communication module 1535 to a server responsible for the respective address space (e.g. having a direct access to the required address space) for appropriate handling.

Referring to FIG. 3, there is illustrated a schematic functional block diagram of the SAS Disk Unit (e.g. Disk Unit 170 illustrated in FIG. 1) in accordance with certain embodiments of the present invention. The disk unit comprises a plurality of disk drives 1720. The disk drives may be either SAS drives, SATA drives or other disk drives supported by SAS technology. The DU comprises one or more SAS I/O modules (illustrated as SAS I/O modules 1710 and 1715). The disk drives in the DU may be operatively connected to one or more of the I/O modules. As illustrated in FIG. 3, each disk drive in the disk unit is connected to both SAS I/O modules 1710 and 1715, so that double access to each drive is assured.

Each of two illustrated I/O modules comprises two or more Internal SAS Expanders (illustrated as 1740, 1742, 1744, 1746). In general, SAS expanders can be configured to behave as either targets or initiators. In accordance with certain embodiments of the present invention, the Internal SAS Expanders 1740 are configured to act as SAS targets with regard to the SAS expanders 160, and as initiators with regard to the connected disks. The internal SAS expanders may enable increasing the number of disk drives in a single disk unit and, accordingly, expanding the address space available via the storage control grid within constrains of limited number of ports and/or available bandwidth.

The I/O modules may further comprise a plurality of Mini SAS units (illustrated as units 1730, 1732, 1734 and 1736) each connected to respective Internal SAS expanders. The Mini SAS unit, also known in the art as a “wide port”, is a module operable to provide physical connection to a plurality of SAS point-to-point connections grouped together and to enable multiple simultaneous connections to be open between a SAS initiator and multiple SAS targets (e.g. internal SAS expanders in the illustrated architecture).

The disk drives may be further provided with MUX units 1735 in order to increase the number of physical connections available for the disks.

Referring back to FIG. 1, the illustrated architecture of SAS-based grid storage system enables any request directed to any LU to reach the desired LBA via any of the servers, wherein each server covers the entire space address of the disk drives in the storage system. An I/O request coming from a host is initially handled by the CPU 1510 operable to define which data needs to be read or written and from/to which physical location. The request is further forwarded to the respective disk unit via the HBAs 1550 or 1555 and one of the SAS expanders 160, and arrives at the relevant disk unit via one of the internal SAS expanders 1740. No further intervention of CPU is needed along the way after the handling of the request within the Storage Control Grid 102.

Although in terms of software and protocols, SAS technology supports thousands of devices allowed to communicate with each other, physical constrains may limit the number of accessible LBAs. Physical constrains may be caused, by way of non-limiting example, by limited number of connections in implemented enclosure and/or limited target recognition ability of an implemented chipset and/or by rack configuration limiting a number of expanders, and/or by limitations of available bandwidth required for communication between different blocks, etc. Certain embodiments of architecture detailed with reference to FIG. 1 enable significant overcoming such limitations and providing direct access to any LBA in the disk units directly connected to the SAS expanders 160, wherein the number of such directly accessed LBAs may be of the same order as the number allowed by the SAS protocol.

Constrains of limited number of ports and/or available bandwidth and/or other physical constrains may be also overcome in certain alternative embodiments of the present invention illustrated in FIG. 4. The storage control grid is constituted by servers 105A 105C detailed with reference to FIGS. 1 and 2 and operatively connected to a plurality of disk units detailed with reference to FIG. 3. Groups of two or more DUs are configured to form a “daisy chain” (illustrated as three groups of three DUs constituting three daisy chains 270-271-272, 273-275-275 and 276-277-278). The first and the last DUs in each daisy chain are directly connected to at least two servers, the connection is provided independently of other daisy chains. Table I illustrates connectivity within the daisy chain 270-271-272. The columns in the table indicate DUs, the rows indicate the reference number of the Mini SAS within respective DU (according to reference numbers illustrated in FIG. 3, and interceptions indicate the respective connections (SAS HBAs reference numbers are provided in accordance with FIG. 2). Thus, for instance, Mini SAS 1732 of DU 270, is connected to HBA 152 of sever 150A, and Mini SAS 1732 of DU 271 is connected to Mini SAS 1736 of DU 270.

TABLE 1

| | 1730 | 1732 | 1734 | 1736 |
|---|---|---|---|---|
| 270 | 1554 of 150B | 1552 of 150A | 1730 of 271 | 1732 of 271 |
| 271 | 1734 of 270 | 1736 of 270 | 1730 of 272 | 1732 of 272 |
| 272 | 1734 of 271 | 1736 of 271 | 1550 of 150A | 15562 of 150B |

Mini SAS connectors of I/O modules of a first DU connected to a server or other DUs connected to a previous DU (e.g. 1730 and 1732) are configured to act as targets, whereas Mini SAS connectors in another I/O module (e.g. 1734 and 1736) are configured to act as initiators.

In contrast to the architecture described with reference to FIG. 1, in the architecture illustrated in FIG. 4 each server has direct access only to a part of the entire space address of the disk drives in the storage system (two-thirds of the disks in the illustrated example as each server is connected to only two out of three daisy chains). However, similar to architecture described with reference to FIG. 1, any request directed to any LU may reach the desired LBA via any of the servers in a manner detailed with reference to FIG. 2. When the server receives an I/O request, the interface module 1530 checks if the request is directed to the address space within the responsibility of said server. If the request (or part thereof) is directed to an address space out of the server's responsibility, the request is re-directed via the inter-server communication module 1535 to a server responsible for the respective address space (e.g. having a direct access to the required address space) for appropriate handling.

The redundant hardware architecture illustrated with reference to FIGS. 1 and 4 provides the storage system of the present invention with failure tolerance.

In certain embodiments of the present invention availability and failure tolerance of the storage system may be further increased by configuring the servers. In such embodiments, although each server is provided with direct or indirect access to the entire address space, a responsibility for entire address space is divided between the servers. For example, each LBA may be assigned to a server with a primary responsibility (referred to hereinafter as a “primary server”) and a server with a secondary responsibility (referred to hereinafter as a “secondary server”) for said LBA. In certain embodiments of the invention the primary server may be configured to have direct access to the address space controlled with primary responsibility wherein the secondary server may be configured to have direct and/or indirect access to this address space. All I/O requests directed to a certain LBA are handled by respective primary server. If a certain I/O request is received by a server which is not the primary server with respect to the desired LBA, the request is forwarded to a corresponding primary server. The primary server is operable to temporarily store the data and metadata related to the I/O request in its cache, and to handle the data so that it ends up being permanently stored in the correct address and disk drive. The primary server is further operable to send a copy of the data/metadata stored in the cache memory to the secondary server with respect to the desired LBA. The primary server acknowledges the transaction to the host only after the secondary server has acknowledged back that the data is in cache. After the primary server stores the data permanently in the disk drives, it informs the secondary server that it can delete the copy of data from its cache. If the primary server fails or shuts down before the data has been permanently stored in the disks drives, the secondary server overtakes responsibility for said LBA and for appropriate permanent storing of the data.

In order to further increase availability of the storage system and to enable a tolerance to a double hardware failure, each LBA may be assigned to three servers: primary server, main secondary server and auxiliary secondary server. When handling an I/O request, the primary server sends copies of data/metadata stored in its cache memory to the secondary servers and acknowledges the transaction after both secondary servers have acknowledged that they have stored the data in respective cache memories. After the primary server stores that data permanently in the disk drives, it informs both secondary servers that the respective copies of data may be deleted. If the primary server fails or is shut down before the data has been permanently stored in the disk drives, then the main secondary server will overtake responsibility for said LBA. However, if a double failure occurs, the auxiliary secondary server will overtake responsibility for said LBA and for appropriate permanent storing of the data.

Those versed in the art will readily appreciate that the invention is not bound by the architecture of the grid storage system described with reference to FIGS. 1-4. Equivalent and/or modified functionality may be consolidated or divided in another manner and may be implemented in any appropriate combination of software, firmware and hardware. In different embodiments of the invention the functional blocks and/or parts thereof may be placed in a single or in multiple geographical locations (including duplication for high-availability); operative connections between the blocks and/or within the blocks may be implemented, when necessary, via a remote connection. Alternative embodiments illustrated in FIGS. 1 and 4 may be combined within a certain storage system.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present invention.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A storage system comprising:
a) a storage control grid comprising a plurality of interconnected data servers operable in accordance with at least one SAS protocol; and
b) a plurality of disk units adapted to store data at respective ranges of logical block addresses (LBAs), said addresses constituting an entire address space;
wherein each disk unit comprises at least one input/output (IO) module comprising at least one internal SAS expander operative in accordance with at least one SAS protocol and configured as a target with regard to the storage control grid, and
wherein the plurality of disk units is operatively connected to the storage control grid in a manner enabling to each data server comprised in the storage control grid an access to each disk unit among the plurality of disk units.

2. The storage system of claim 1 wherein the storage control grid further comprises a plurality of SAS expanders, each SAS expander directly connected to at least two interconnected data servers and each data server is directly connected to at least two SAS expanders, and wherein each disk unit is directly connected to at least two SAS expanders and each SAS expander is directly connected to all disk units thus enabling direct access of each data server to the entire address space.

3. The storage system of claim 2 wherein each disk unit comprises at least two I/O modules each comprising at least two internal SAS expanders, and wherein each disk drive comprised in a certain disk unit is connected to at least one internal SAS expander in each of the I/O modules.

4. The storage system of claim 1 wherein each data server is configured to be responsible for handling I/O requests directed to a respective part of the entire address space, each certain data server is further operative to recognize among received I/O requests a request directed to an address space out of the server's responsibility and to re-directed such request to a server responsible for the desired address space.

5. The storage system of claim 4 wherein the data servers are configured to be responsible for handling I/O requests addressed to directly accessible address space.

6. The storage system of claim 1 wherein no processing power is required for handling an I/O request within the plurality of disk units.

7. The storage system of claim 1 wherein at least two disk units in the plurality of disk units are connected in one or more daisy chains, the first and the last disk units in each daisy chain are directly connected to at least two servers, the connection is provided independently of other daisy chains.

8. The storage system of claim 7 wherein each data server connected to one or more said daisy chains is configured, responsive to an I/O request from a host processor directed to a certain LBA, to re-direct the I/O request to another server if said LBA is not comprised in the LBA ranges of disk units in respective daisy chains connected to said server.

9. The storage system of claim 7 wherein each disk unit comprises at least two I/O modules each comprising at least two internal SAS expanders, and wherein each disk drive comprised in a certain disk unit is connected to at least one internal SAS expander in each of the I/O modules.

10. The storage system of claim 9 wherein each I/O module further comprises at least two Mini SAS each connected to a respective internal SAS expanders and enabling required interconnection of disk units with respective servers and/or within the daisy chains.

11. The storage system of claim 1 wherein
a) each LBA is assigned to at least two data servers, a primary data server configured to have a primary responsibility for permanent storing of data and/or metadata related to the desired LBA, and a secondary data server configured to take over the responsibility for said permanent storing in an event of a failure of the primary data server;
b) all I/O requests directed to a certain LBA are handled by respective primary data server, said primary data server operable
i) to temporarily store the data and metadata with respect to desired LBA,
ii) to send a copy of said data/metadata to respective secondary data server for temporarily storing; and
iii) to send a permission to the secondary data server to delete the copy of data/metadata upon successful permanent storing said data/metadata.

12. The system of claim 11 wherein each data server has a direct access to the address space handled with the primary responsibility.

13. The system of claim 12 wherein each data server has direct or indirect access to the address space handled with the take-over responsibility.

14. The storage system of claim 1 wherein
a) each LBA is assigned to at least three data servers, a primary data server configured to have a primary responsibility for permanent storing of data and/or metadata related to the desired LBA, a main secondary data server configured to take over the responsibility for said permanent storing in an event of a failure of the primary data server, and an auxiliary secondary server configured to take over the responsibility for said permanent storing in an event of a failure of the main secondary data server;
b) all I/O requests directed to a certain LBA are handled by respective primary server, said primary server operable
i) to temporarily store the data and metadata with respect to desired LBA,
ii) to send copies of said data/metadata to respective main and auxiliary secondary servers for temporarily storing; and
iii) to send permissions to the main and auxiliary secondary servers to delete the copies of data/metadata upon successful permanent storing said data/metadata.

15. The system of claim 14 wherein each data server has a direct access to the address space handled with the primary responsibility.

16. The system of claim 15 wherein each data server has direct or indirect access to the address space handled with the take-over responsibility.

17. The storage system of claim 2 wherein
a) each LBA is assigned to at least two data servers, a primary data server configured to have a primary responsibility for permanent storing of data and/or metadata related to the desired LBA, and a secondary data server configured to take over the responsibility for said permanent storing in an event of a failure of the primary data server;
b) all I/O requests directed to a certain LBA are handled by respective primary data server, said primary data server operable
i) to temporarily store the data and metadata with respect to desired LBA,
ii) to send a copy of said data/metadata to respective secondary data server for temporarily storing; and
iii) to send a permission to the secondary data server to delete the copy of data/metadata upon successful permanent storing said data/metadata.

18. The storage system of claim 2 wherein
a) each LBA is assigned to at least three data servers, a primary data server configured to have a primary responsibility for permanent storing of data and/or metadata related to the desired LBA, a main secondary data server configured to take over the responsibility for said permanent storing in an event of a failure of the primary data server, and an auxiliary secondary server configured to take over the responsibility for said permanent storing in an event of a failure of the main secondary data server;
b) all I/O requests directed to a certain LBA are handled by respective primary server, said primary server operable
i) to temporarily store the data and metadata with respect to desired LBA,
ii) to send copies of said data/metadata to respective main and auxiliary secondary servers for temporarily storing; and
iii) to send permissions to the main and auxiliary secondary servers to delete the copies of data/metadata upon successful permanent storing said data/metadata.

19. The storage system of claim 7 wherein
a) each LBA is assigned to at least two data servers, a primary data server configured to have a primary responsibility for permanent storing of data and/or metadata related to the desired LBA, and a secondary data server configured to take over the responsibility for said permanent storing in an event of a failure of the primary data server;
b) all I/O requests directed to a certain LBA are handled by respective primary data server, said primary data server operable
i) to temporarily store the data and metadata with respect to desired LBA,
ii) to send a copy of said data/metadata to respective secondary data server for temporarily storing; and
iii) to send a permission to the secondary data server to delete the copy of data/metadata upon successful permanent storing said data/metadata.

20. The storage system of claim 7 wherein
a) each LBA is assigned to at least three data servers, a primary data server configured to have a primary responsibility for permanent storing of data and/or metadata related to the desired LBA, a main secondary data server configured to take over the responsibility for said permanent storing in an event of a failure of the primary data server, and an auxiliary secondary server configured to take over the responsibility for said permanent storing in an event of a failure of the main secondary data server;
b) all I/O requests directed to a certain LBA are handled by respective primary server, said primary server operable
i) to temporarily store the data and metadata with respect to desired LBA,
ii) to send copies of said data/metadata to respective main and auxiliary secondary servers for temporarily storing; and
iii) to send permissions to the main and auxiliary secondary servers to delete the copies of data/metadata upon successful permanent storing said data/metadata.

21. A method of operating a storage system comprising a storage control grid comprising a plurality of interconnected data servers operable in accordance with at least one SAS protocol; and a plurality of disk units adapted to store data at respective ranges of logical block addresses (LBAs), wherein said plurality of disk units is operatively connected to the storage control grid in a manner enabling to each data server comprised in the storage control grid an access to each disk unit among the plurality of disk units, the method comprising:
a) assigning each LBA to at least two data servers, a primary data server configured to have a primary responsibility for permanent storing of data and/or metadata related to the desired LBA, and a secondary data server configured to take over the responsibility for said permanent storing in an event of a failure of the primary data server;
b) responsive to an I/O requests directed to a certain LBA, temporarily storing the data and metadata with respect to desired LBA in the primary data server;
c) sending a copy of said data/metadata from the primary data server to respective secondary data server for temporarily storing; and
d) sending a permission from the primary data server to the secondary data server to delete the copy of data/metadata upon successful permanent storing said data/metadata.

22. A method of operating a storage system comprising a storage control grid comprising a plurality of interconnected data servers operable in accordance with at least one SAS protocol; and a plurality of disk units adapted to store data at respective ranges of logical block addresses (LBAs), wherein said plurality of disk units is operatively connected to the storage control grid in a manner enabling to each data server comprised in the storage control grid an access to each disk unit among the plurality of disk units, the method comprising:
a) assigning each LBA to at least three data servers, a primary data server configured to have a primary responsibility for permanent storing of data and/or metadata related to the desired LBA, a main secondary data server configured to take over the responsibility for said permanent storing in an event of a failure of the primary data server, and an auxiliary secondary server configured to take over the responsibility for said permanent storing in an event of a failure of the main secondary data server;
b) responsive to an I/O requests directed to a certain LBA, temporarily storing the data and metadata with respect to desired LBA in the primary data server;
c) sending copies of said data/metadata from the primary data server to respective main and auxiliary secondary data servers for temporarily storing; and
d) sending a permission from the primary data server to the main and auxiliary secondary data servers to delete the copies of data/metadata upon successful permanent storing said data/metadata.

23. A computer program comprising computer program code means for performing the method of claim 22 when said program is run on a computer.

24. A computer program as claimed in claim 23 embodied on a computer readable medium.

25. The system of claim 1 operable in accordance with a protocol selected from a group comprising file-access storage protocols, block-access storage protocols and object-access storage protocols.
